(19) United States
(12) Patent Application Publication
(10) Pub. No.: US 2012/0082328 A1
(43) Pub. Date: Apr. 5, 2012

(54) AUDIO REPRODUCTION DEVICE AND A METHOD FOR USING THE AFOREMENTIONED DEVICE

(75) Inventors: Wong Hoo SIM, Singapore (SG); Thean Kuie Christopher CHANG, Singapore (SG)

(73) Assignee: CREATIVE TECHNOLOGY LTD, Singapore (SG)

(21) Appl. No.: 12/896,730

(22) Filed: Oct. 1, 2010

(51) Int. Cl. H04R 5/02

(52) U.S. Cl. 381/311; 381/309

(57) ABSTRACT

There is provided an audio reproduction device capable of providing audio output through at least one output member and a corresponding method for using the audio reproduction device. The audio reproduction device includes a left output member for transmission of audio, the left output member being able to fit into a user's first ear; a transducer for converting input audio signals into audio output, the transducer being directly coupled to the left output member; an acoustic tube coupled to the left output member for transmission of audio from the transducer, a first end of the acoustic tube being coupled to the left output member; and a right output member for transmission of audio, the right output member being able to fit into the user's second ear, a second end of the acoustic tube being coupled to the right output member.

### FIELD OF INVENTION

The present invention relates to the field of audio reproduction, particularly, an audio reproduction device and a method for using the audio reproduction device.

### BACKGROUND

It is a common practice that personal audio reproduction devices such as, for example, headphones and earphones typically require at least one driver (transducer) for each ear such that audio is transmitted directly into each ear of a user from the drivers. This enables the user to perceive the audio in a stereo manner, and the audio transmitted into each ear allows the user to achieve a sense of aural balance.

However, it should be noted that complexities of construction, power consumption, and weight of the personal audio reproduction devices all correspondingly increase in proportion with a number of drivers used in each of the personal audio reproduction devices. Given that the personal audio reproduction devices are usually portable and commonly used in such a manner, it would be desirable if the weight of the devices could be minimized. Furthermore, it would be desirable if the power consumption by the personal audio reproduction devices were minimized since the personal audio reproduction devices are typically connected to portable devices with limited power capacity to provide power for both the portable devices and the personal audio reproduction devices over an extended duration of time. Moreover, it is also desirable if the construction was not overly complex so that the personal audio reproduction devices are more robust.

In view of the aforementioned issues, it would be desirable if complexities of construction, weight and power consumption of the personal audio reproduction devices could be minimized without adversely affecting the usability of the personal audio reproduction devices.

### SUMMARY

In a first aspect, there is provided an audio reproduction device capable of providing audio output through at least one output member. The audio reproduction device includes a left output member for transmission of audio, the left output member being able to fit into a user's first ear; a transducer for converting input audio signals into audio output, the transducer being directly coupled to the left output member; an acoustic tube coupled to the left output member for transmission of audio from the transducer, a first end of the acoustic tube being coupled to the left output member; and a right output member for transmission of audio, the right output member being able to fit into the user's second ear, a second end of the acoustic tube being coupled to the right output member. It is advantageous that the audio output is transmitted from the transducer through the acoustic tube to the right output member, and the right output member is removable from the audio reproduction device.

The audio reproduction device may also include a wireless receiver coupled to the transducer to receive input audio signals. The input of audio signals may be received by the transducer via either a physical connection or a wireless connection. The wireless receiver may employ a wireless technology such as, for example, infra-red, RF, Bluetooth and so forth. The audio reproduction device may also include a power source coupled to the transducer, the power source being for powering the transducer.

It is advantageous that varying the acoustic tube affects the audio output transmitted to the right output member, the audio output being affected by either phase shift or attenuation. The varying of the acoustic tube may be carried out by varying either a length or a material of the acoustic tube.

The first end of the acoustic tube may be removable from the left output member and the second end of the acoustic tube may be removable from the right output member. Alternatively, the second end of the acoustic tube may be affixed to the right output member.

It is preferable that both the left output member and the right output member allow ambient sounds to enter the user's first and second ears respectively.

In a second aspect, there is provided a method for using an audio reproduction device capable of providing audio output through at least one output member. The method includes receiving input audio signals at a transducer for converting the input audio signals to produce audio output; powering the transducer to produce the audio output, the transducer being coupled to a left output member, the left output member being able to fit into a user's first ear; and coupling a first end of an acoustic tube to the left output member, a second end of the acoustic tube being coupled to a right output member, the right output member being able to fit into the user's second ear, with the acoustic tube being for transmission of audio from the transducer. Advantageously, the audio output is transmitted from the transducer through the acoustic tube to the right output member, and the right output member is removable from the audio reproduction device.

The input audio signals may be received at the transducer via either a physical connection or a wireless connection. The wireless connection may employ a wireless technology such as, for example, infra-red, RF, Bluetooth and so forth.

It is advantageous that varying the acoustic tube affects the audio output transmitted to the right output member, the audio output being affected by either phase shift or attenuation. The variation of the acoustic tube may be carried out by varying either a length or a material of the acoustic tube.

It is preferable that both the left output member and the right output member allow ambient sounds to enter the user's first and second ears respectively.

### DESCRIPTION OF DRAWINGS

In order that the present invention may be fully understood and readily put into practical effect, there shall now be described by way of non-limitative example only preferred embodiments of the present invention, the description being with reference to the accompanying illustrative drawings.

FIG. 1 shows a schematic view of a device of the present invention.

FIG. 2 shows a process flow of a method of the present invention.

### DESCRIPTION OF PREFERRED EMBODIMENTS

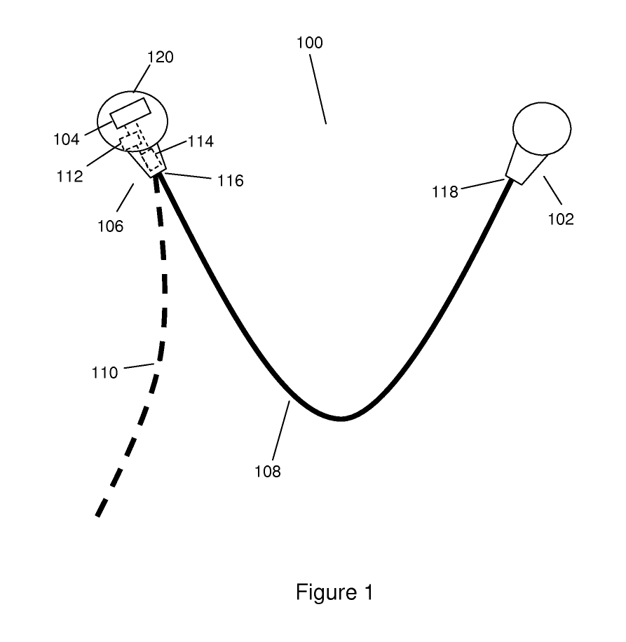

Referring to FIG. 1 which shows a schematic view of an audio reproduction device 100, there is provided the audio reproduction device 100 which is capable of providing audio output through at least one output member. The at least one output member may be placed either at an entrance of a user's ear canal or within the user's ear canal. In the embodiment as shown in FIG. 1, the audio reproduction device 100 is an earphone set. The audio reproduction device 100 may be used in a portable manner, and it would be preferable if the weight of the audio reproduction device 100 was minimized so as not to cause weight-based discomfort to a user of the audio reproduction device 100, particularly at the ears of the user. It should be appreciated that dotted lines of physical features in FIG. 1 indicate a non-mandatory/an optional feature denoted in FIG. 1.

The audio reproduction device 100 includes a left output member 106 for transmission of audio, the left output member 106 being able to fit into the user's first ear (not shown). The left output member 106 may allow ambient sounds to enter the user's first ear. This aspect may be beneficial during instances when the user needs to be consciously aware of the goings-on at the surroundings which the user is in. The audio reproduction device 100 may include a transducer 104 for converting input audio signals into audio output, the transducer 104 being directly coupled to the left output member 106.

While the transducer 104 is shown to be located within a left casing 120 of the left output member 106 in FIG. 1, it should be appreciated that the transducer 104 need not be located within the left casing 120 of the left output member 106.

There is also an acoustic tube 108 coupled to the left output member 106 for transmission of audio output from the transducer 104. A first end 116 of the acoustic tube 108 is coupled to the left output member 106. The coupling of the first end 116 of the acoustic tube 108 and the left output member 106 should be securable and not prone to un-intentional de-coupling during regular use. As such, the first end 116 of the acoustic tube 108 may employ securing mechanisms such as, for example, clips, jack-socket combination, Velcro strips, adhesive strips and so forth. It should be noted that the acoustic tube 108 is able to have different characteristics which affects the transmission of audio from the transducer 104. The acoustic tube 108 may have different characteristics due to varying either a length or a material of the acoustic tube 108. The acoustic tube 108 may affect, for example, an extent of phase shifting for the transmitted audio output, an extent of attenuation for the transmitted audio output and so forth. However, it should be appreciated that even though the audio output transmitted from the transducer 104 is affected by the acoustic tube 108, the effect on the audio output at the right output member 102 should not affect the sense of aural balance experienced by the user.

The audio reproduction device 100 also includes a right output member 102 for transmission of audio output, the right output member 102 being able to fit into the user's second ear (not shown). The right output member 102 may allow ambient sounds to enter the user's second ear. This aspect may be beneficial during instances when the user needs to be consciously aware of the goings-on at the surroundings which the user is in. A second end 118 of the acoustic tube 108 may be coupled to the right output member 102. The coupling of the second end 118 of the acoustic tube 108 and the right output member 102 should be securable and not prone to un-intentional de-coupling during regular use. As such, the second end 118 of the acoustic tube 108 may employ securing mechanisms such as, for example, clips, jack-socket combination, Velcro strips, adhesive strips and so forth. It should be noted that the second end 118 of the acoustic tube 108 may be affixed to the right output member 102 such that both the acoustic tube 108 and the right output member 102 form a single part of the audio reproduction device 100. In this regard, varying the acoustic tube 108 of the audio reproduction device 100 may also mean changing the right output member 102.

The transducer 104 of the audio reproduction device 100 may receive the input audio signals via either a physical connection or a wireless connection. The physical connection may be a cable 110 directly linked with the transducer 104, where the input audio signals are from a source of audio signals. The audio reproduction device 100 may also include a wireless receiver 112 coupled to the transducer 104 to receive input audio signals wirelessly from the source of audio signals. The wireless receiver 112 may employ a wireless technology of, for example, infra-red, RF, Bluetooth and so forth. It should be appreciated that the audio reproduction device 100 may include both the cable 110 and the wireless receiver 112 such that the user is able to choose between either the physical connection or the wireless connection for the input of audio signals.

Finally, the audio reproduction device 100 may also include a power source 114 coupled to the transducer 104 for powering the transducer 104 and other components of the audio reproduction device 100. It should be appreciated that the power source 114 may not be required if power for all the components of the audio reproduction device 100 is drawn from the source of audio signals via the cable 110.

It should be appreciated that the audio reproduction device 100 operates in a manner where the audio output is transmitted from the transducer 104 through the acoustic tube 108 to the right output member 102. It should be noted that the acoustic tube 108 and the right output member 102 is removable from the audio reproduction device 100 (either as a single part or separate parts). The removal of the right output member 102 may be carried out when the user desires audio output from a single output member. When the right output member 102 is removed from the audio reproduction device 100, audio output is provided by only the left output member 106 to the first ear of the user. This advantageously provides the user with an option to enjoy audio output though either only the left output member 106 or both the left output member 106 and the right output member 102. When the right output member 102 is removed, there is no instance of the right output member 102 being dangled from the audio reproduction device 100, as per instances involving typical earphones. In this regard, it is appreciated that the removal of the right output member 102 aids the user who wishes to listen to audio output from only the left output member 106 as the user avoids a need to deal with a dangling right output member 102.

It should be appreciated that the single transducer 104 aspect of the audio reproduction device 100 simplifies construction of the audio reproduction device 100, minimizes weight of the audio reproduction device 100 and also minimizes power consumption of the audio reproduction device 100. Furthermore, the audio reproduction device 100 is versatile as it is usable with only a single output member.

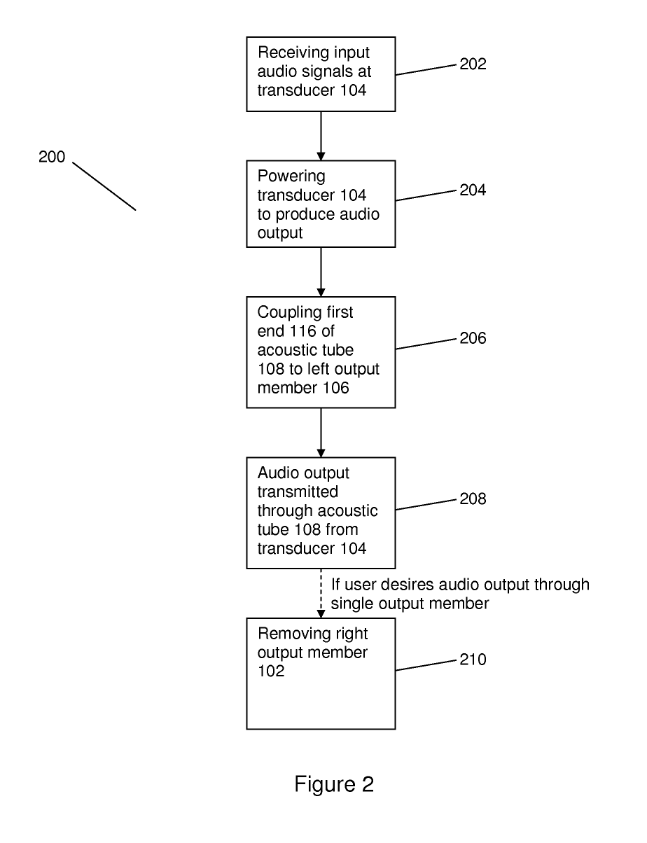

Referring to FIG. 2, there is provided a method 200 for using an audio reproduction device such as the audio reproduction device 100 as described in the preceding paragraphs, where audio output is provided through at least one output member. The audio reproduction device 100 may be used in a portable manner, and it would be preferable if the weight of the audio reproduction device 100 was minimized so as not to cause weight-based discomfort to a user of the audio reproduction device 100, particularly at the ears of the user.

In a preferred embodiment, the method 200 described with reference to the audio reproduction device 100 (for the sake of illustration) includes receiving input audio signals at the transducer 104 for converting the input audio signals to produce audio output (202). The transducer 104 may receive the input audio signals via either a physical connection or a wireless connection. The physical connection may be a cable 110 directly linked with the transducer 104, where the input audio signals are from a source of audio signals. The audio reproduction device 100 may also include a wireless receiver 112 coupled to the transducer 104 to receive input audio signals wirelessly from the source of audio signals. The wireless receiver 112 may employ a wireless technology such as, for example, infra-red, RF, Bluetooth and so forth. It should be appreciated that the audio reproduction device 100 may include both the cable 110 and the wireless receiver 112 such that the user is able to choose between either the physical connection or the wireless connection for the input of audio signals.

The method 200 also includes powering the transducer 104 to produce the audio output (204). The transducer 104 may be coupled to a left output member 106 which may be able to fit into the user's first ear. A power source may be coupled to the transducer 104, or power to the transducer 104 may be drawn from the source of audio signals via the cable 110. The left output member 106 may allow ambient sounds to enter the user's first ear. While the transducer 104 is shown to be located within a left casing 120 of the left output member 106 in FIG. 1, it should be appreciated that the transducer 104 need not be located within the left casing 120 of the left output member 106.

The method 200 also includes coupling the first end 116 of the acoustic tube 108 to the left output member 106 (206). The second end 118 of the acoustic tube 108 may be being coupled to the right output member 102, the right output member 102 being able to fit into the user's second ear and the acoustic tube 108 is for transmission of audio from the transducer 104. The right output member 102 may allow ambient sounds to enter the user's second ear. The coupling of the first end 116 of the acoustic tube 108 and the left output member 106 should be securable and not prone to un-intentional de-coupling during regular use. As such, the first end 116 of the acoustic tube 108 may employ securing mechanisms such as, for example, clips, jack-socket combination, Velcro strips, adhesive strips and so forth. A coupling of the second end 118 of the acoustic tube 108 and the right output member 102 should also be securable and not prone to un-intentional de-coupling during regular use. As such, the second end 118 of the acoustic tube 108 may also employ securing mechanisms such as, for example, clips, jack-socket combination, Velcro strips, adhesive strips and so forth. It should be noted that the second end 118 of the acoustic tube 108 may be affixed to the right output member 102 such that both the acoustic tube 108 and the right output member 102 form a single part of the audio reproduction device 100. The output members 102, 106 may be placed either at an entrance of a user's ear canal or within the user's ear canal.

In the method 200, the audio output is transmitted through the acoustic tube 108 to the right output member 102 from the transducer 104 (208). It should be noted that the acoustic tube 108 is able to have different characteristics which affects the transmission of audio output from the transducer 104. The acoustic tube 108 may have different characteristics due to varying either a length or a material of the acoustic tube 108. The acoustic tube 108 may affect, for example, an extent of phase shifting for the transmitted audio, an extent of attenuation for the transmitted audio and so forth. However, it should be appreciated that even though the audio output transmitted from the transducer 104 is affected by the acoustic tube 108, the effect on the audio output at the right output member 102 should not affect the sense of aural balance experienced by the user.

Furthermore, in an instance when the user desires audio output from a single output member, the right output member 102 is also removable from the audio reproduction device 100 (210). It should be noted that the acoustic tube 108 and the right output member 102 is removable from the audio reproduction device 100 (either as a single part or separate parts). When the right output member 102 is removed from the audio reproduction device 100, audio output is provided by only the left output member 106 to the first ear of the user. This advantageously allows the user to enjoy audio output though either only the left output member 106 or both the left output member 106 and the right output member 102. When the right output member 102 is removed, there is no instance of the right output member 102 being dangled from the audio reproduction device 100, as per instances involving typical earphones. In this regard, it is appreciated that the removal of the right output member 102 aids the user who wishes to listen to audio output from the left output member 106 as the user avoids a need to deal with a dangling right output member 102.

It should be appreciated that the single transducer 104 aspect in relation to the method 200 enables simplification of construction of the audio reproduction device 100, minimizes weight of the audio reproduction device 100 and also minimizes power consumption of the audio reproduction device 100. Furthermore, the audio reproduction device 100 is versatile as it is usable with only a single output member.

Whilst there has been described in the foregoing description preferred embodiments of the present invention, it will be understood by those skilled in the technology concerned that many variations or modifications in details of design or construction may be made without departing from the present invention.

1. An audio reproduction device capable of providing audio output through at least one output member, the audio reproduction device including:
a left output member for transmission of audio, the left output member being able to fit into a user's first ear;
a transducer for converting input audio signals into audio output, the transducer being directly coupled to the left output member;
an acoustic tube coupled to the left output member for transmission of audio from the transducer, a first end of the acoustic tube being coupled to the left output member; and
a right output member for transmission of audio, the right output member being able to fit into the user's second ear, a second end of the acoustic tube being coupled to the right output member,
wherein the audio output is transmitted from the transducer through the acoustic tube to the right output member, and the right output member is removable from the audio reproduction device.

2. The audio reproduction device of claim 1, further including a wireless receiver coupled to the transducer to receive input audio signals.

3. The audio reproduction device of claim 2, wherein the input audio signals are received by the transducer via either a physical connection or a wireless connection.

4. The audio reproduction device of claim 2, wherein the wireless receiver employs a wireless technology selected from a group comprising: infra-red, RF, and Bluetooth.

5. The audio reproduction device of claim 1, further including a power source coupled to the transducer, the power source being for powering the transducer.

6. The audio reproduction device of claim 1, wherein varying the acoustic tube affects the audio output transmitted to the right output member, the audio output being affected by either phase shift or attenuation.

7. The audio reproduction device of claim 6, wherein varying the acoustic tube is carried out by varying either a length or a material of the acoustic tube.

8. The audio reproduction device of claim 1, wherein the first end of the acoustic tube is removable from the left output member and the second end of the acoustic tube is removable from the right output member.

9. The audio reproduction device of claim 1, wherein the second end of the acoustic tube is affixed to the right output member.

10. The audio reproduction device of claim 1, wherein both the left output member and the right output member allow ambient sounds to enter the user's first and second ears respectively.

11. A method for using an audio reproduction device capable of providing audio output through at least one output member, the method including:
receiving input audio signals at a transducer for converting the input audio signals to produce audio output;
powering the transducer to produce the audio output, the transducer being coupled to a left output member, the left output member being able to fit into a user's first ear; and
coupling a first end of an acoustic tube to the left output member, a second end of the acoustic tube being coupled to a right output member, the right output member being able to fit into the user's second ear, with the acoustic tube being for transmission of audio from the transducer;
wherein the audio output is transmitted from the transducer through the acoustic tube to the right output member, and the right output member is removable from the audio reproduction device.

12. The method of claim 11, wherein the input audio signals are received at the transducer via either a physical connection or a wireless connection.

13. The method of claim 12, wherein the wireless connection employs a wireless technology selected from a group comprising: infra-red, RF, and Bluetooth.

14. The method of claim 11, wherein varying the acoustic tube affects the audio output transmitted to the right output member, the audio output being affected by either phase shift or attenuation.

15. The method of claim 14, wherein varying the acoustic tube is carried out by varying either a length or a material of the acoustic tube.

16. The method of claim 11, wherein both the left output member and the right output member allow ambient sounds to enter the user's first and second ears respectively.
